(19) United States
(12) Patent Application Publication
(10) Pub. No.: US 2015/0208069 A1
(43) Pub. Date: Jul. 23, 2015

(54) METHODS AND APPARATUSES FOR CONTENT-ADAPTIVE QUANTIZATION PARAMETER MODULATION TO IMPROVE VIDEO QUALITY IN LOSSY VIDEO CODING

(71) Applicant: Magnum Semiconductor, Inc., Milpitas, CA (US)

(72) Inventors: Lin Zheng, Waterloo (CA); Pavel Novotny, Waterloo (CA)

(73) Assignee: Magnum Semiconductor, Inc., Milpitas, CA (US)

(21) Appl. No.: 14/161,930

(22) Filed: Jan. 23, 2014

(51) Int. Cl. H04N 19/124; H04N 19/463; H04N 19/176

(52) U.S. Cl. CPC H04N 19/124; H04N 19/176; H04N 19/463

(57) ABSTRACT

A technique for improving the subject visual quality of encoded video that includes a video quality module configured to determine a video quality metric (VQM) for each data block of a plurality of data blocks and a modulator coupled to the video quality module. The modulator configured to modulate a video encoding parameter to improve the quality for each data block of the plurality of data blocks based on a normalized VQM for each data block of the plurality of data blocks.

### TECHNICAL FIELD

Embodiments of the present invention relate generally to video encoding and examples of adaptive quantization for encoding are described herein. Examples include methods of and apparatuses for adaptive quantization utilizing content-adaptive quantization parameter modulation to improve visual quality.

### BACKGROUND

Video encoders are often used to encode baseband video data; thereby reducing the number of bits used to store and transmit the video. In most cases the video data is arranged in coding units representing a portion of the overall baseband video data, for example: a frame; a slice; or a macroblock (MB). A typical video encoder may include a macroblock-based block encoder, outputting a compressed bitstream. This encoder may be based on a number of standard codecs, such as MPEG-2, MPEG-4, or H.264. A main bitrate and visual quality (VQ) driving factor in such example video encoders is typically the MB level quantization parameter (QP). A number of standard techniques may be used to select the QP for each MB.

In example video encoders, the QP determines a scale for encoding the video data. Generally, smaller QPs lead to larger amounts of data being retained during quantization processes and larger QPs lead to smaller amounts of data being retained during quantization processes. To improve video quality in lossy video encoding environments, a content-adaptive QP modulation technique may be employed. Additionally, a video characteristic may be derived that the QP modulation may be based upon and this video characteristic may also be used to modulate various other encoding parameters to improve video quality.

### BRIEF DESCRIPTION OF THE FIGURES

FIG. 1 is a block diagram of an encoder according to the present disclosure.

FIG. 2 is a schematic illustration of an example multi-pass encoder implementing adaptive target bitrate modulation according to the present disclosure.

FIG. 3 is a schematic diagram of an example target bitrate modulator according to the present disclosure.

FIG. 4 is a schematic illustration of a visual quality module according to the present disclosure.

FIG. 5 is a schematic illustration an example encoder implementing adaptive QP modulation according to the present disclosure.

FIG. 6 is a schematic diagram of an example distortion-aware QP modulator according to the present disclosure.

FIG. 7 is a flowchart illustrating an example encoding method according to the present disclosure.

FIG. 8 is a schematic illustration of a media delivery system according to the present disclosure.

FIG. 9 is a schematic illustration of a video distribution system that may make use of video encoding systems described herein.

### DETAILED DESCRIPTION

Various example embodiments described herein include content-adaptive quantization parameter and bitrate modulation techniques to improve video quality. Examples of these content-adaptive modulation techniques to improve video quality described herein may advantageously support the provision (e.g., generation) of encoded bitstreams that have an improved visual quality. Example content-adaptive quantization parameter modulation techniques to improve video quality may advantageously allow the properties of the source bitstream, an initial quantization parameter (QP) estimate, and various other values obtained by a pre-encoding step to modulate the QP of at one or more codec stages of an encoder. Example content-adaptive target bitrate modulation techniques to improve video quality may advantageously allow the properties of the source bitstream, and an initial bitrate and a pre-encoding step to modulate the target bitrate used by subsequent encoding processes. Both the QP modulation and the target bitrate modulation schemes may utilize a visual quality metric (VQM) on which to base the modulation of their respective parameters. In this way, improved visual quality (VQ) in a lossy coding environment may be achieved by encoding each coding unit (e.g. macroblock) with a suitable number of bits either based on an updated QP or an updated target bitrate.

Baseband video streams typically include a plurality of pictures (e.g., fields, frames) of video data. Video encoding systems often separate these coding units further into smaller coding units such as macroblocks (MBs). Coding units may also include, but are not limited to, sequences, slices, pictures, groups of pictures, frames and blocks. Each of the coding units may be broken down into other smaller units depending on the size of the starting unit, e.g., a frame may comprise a plurality of MBs.

Video encoders generally perform bit distribution (e.g. determine the number of bits to be used to encode respective portions of a video stream). The bit distribution may be designed to achieve a balanced visual quality. Typical approaches of bit distribution may utilize adaptive quantization methods operating on statistics extracted from the video while not accounting for the nature of the encoder itself. Typically, the baseband video is analyzed and statistics about the video are gathered. These statistics may be used to calculate the QP for each coding unit (e.g. MB). Once the QP for each MB is determined, the MB may be encoded. However, this approach may result in a less than reliable VQ. For example, areas of high texture or particular significance to a viewer, such as faces, may be encoded with too little information to meet a desired VQ level. Additionally, a lossy or noisy coding environment may additionally affect the VQ. To improve the VQ in such environments, a novel statistical-based parameter for each coding unit may be generated, which may then be used to modulate a coding unit's QP and/or a coding unit's target bitrate. By modulating the QP of a coding unit, the bitrate of a coding unit or both, an encoder may improve the subjective video quality of an encoded bitstream.

Example methods and video encoders described herein include modulation of a target bitrate and/or a QP of a coding unit (e.g., a MB) based on a visual quality metric (VQM) generated for the respective coding unit. The VQM may advantageously adapt the QP and/or the target bitrate across all or a portion of a bitstream to improve the video quality of the video. While examples are described herein using a macroblock as an exemplary coding unit, other coding units may be used in other examples.

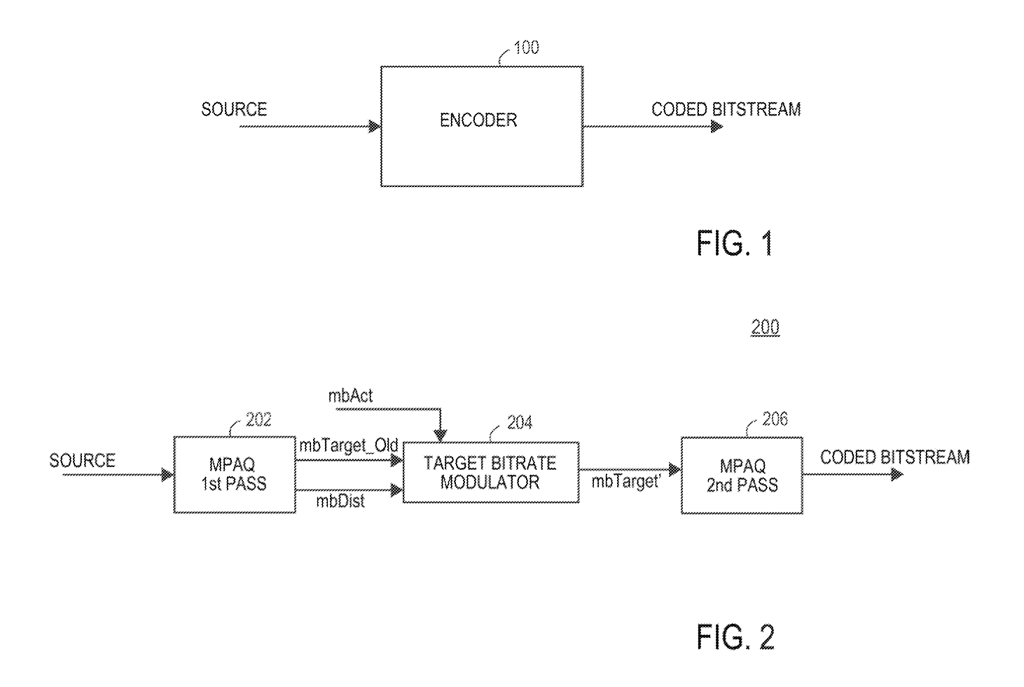

FIG. 1 is a block diagram of an encoder 100 according to an embodiment of the invention. The encoder 100 may include one or more logic circuits, control logic, logic gates, processors, memory, and/or any combination or sub-combination of the same, and may encode and/or compress a video signal using one or more encoding techniques, examples of which will be described further below. The encoder 100 may encode, for example, a variable bit rate signal and/or a constant bit rate signal, and generally may operate at a fixed rate to output a bitstream that may be generated in a rate-independent manner. The encoder 100 may be implemented in any of a variety of devices employing video encoding, including, but not limited to, televisions, broadcast systems, mobile devices, and both laptop and desktop computers.

In at least one embodiment, the encoder 100 may include an entropy encoder, such as a variable-length coding encoder (e.g., Huffman encoder, run-length encoder, or CAVLC encoder), and/or may encode data, for instance, at a macroblock level. Each macroblock may be encoded in intra-coded mode, inter-coded mode, bidirectionally, or in any combination or subcombination of the same.

In an example operation, the encoder 100 may receive and encode a video signal that, in one embodiment, may comprise video data (e.g., frames). The encoder 100 may encode the video signal partially or fully in accordance with one or more encoding standards, such as MPEG-2, MPEG-4, H.263, H.264, H.HEVC, or any combination thereof, to provide an encoded bitstream. The encoded bitstream may be provided to a data bus and/or to a device, such as a decoder or transcoder (not shown).

As will be explained in more detail below, the encoder 100 may adaptively modulate QP per a unit of a frame (e.g., each MB of a frame) to improve the subjective VQ of the frame of video based on the content of the unit and/or the frame. The QP modulation may be based on an initial QP determined by a pre-encoding process along with various other statistics about the frame. Additionally or alternatively, the encoder 100 may adaptively modulate a target bitrate per the unit of the frame of video also to improve the subjective VQ of the frame and also based on the content of the unit and/or frame. The target bitrate modulation may be based on an initial bitrate target and the various other statistics. As noted above, the encoding process takes a source video and encodes the video into a number of bits for transmission—a bitstream. The number of bits used for encoding may depend on the amount of detail in the source (per frame or per MB). The QP can be considered a metric of the detail in the source and may affect the number of bits needed per MB or frame. Consequently, the value of the QP and the number of bits may affect or determine the other. In certain instances, this relationship may be an inverse relationship. For example, a low QP may lead to a higher number of bits and a high QP may lead to a lower number of bits. Hence, the QP and by association the bit number per unit may affect the quality of the encoded video.

To ensure or improve the quality of the video, especially in a lossy coding environment, the QP may be modulated at several encoding steps to produce a high quality video. This process may be performed by a multi-pass adaptive quantization (MPAQ) encoder for each unit of a video source, e.g., each MB of a frame. For every coding unit, the target bitrate may be modulated, hence the QP, as the units proceed through the MPAQ process. The calculation of the target bitrate may utilize various statistics of the frame/MB along with the VQM to determine a subjective visual quality of the video as the video is being encoded. As will be further discussed below, the VQM may be used in various other encoding processes to improve the video quality.

A coding unit's QP may be adjusted to improve the video quality of the encoded bitstream. The QP modulation may use feedback information from the encoder and the QP modulation may be content-adaptive, e.g., the content of the coding unit may be used as a basis for modulating the QP.

FIG. 2 is a schematic illustration of an example multi-pass encoder 200 implementing adaptive target bitrate modulation according to the present disclosure. The encoder 200 may implement target bitrate modulation to improve the video quality of the coded bitstream and may be a multi-pass adaptive quantization encoder. The encoder 200 may include a first pass multi-pass adaptive quantization (MPAQ) encoding module 202, a target bitrate modulator 204 and a second pass MPAQ encoding module 206. The first pass MPAQ encoding module 202 may receive the source data (e.g., a video stream that may be broken into frames with each frame further broken into smaller coding units such as macroblocks, for example) and may perform an initial encoding of the source data using one of the standards discussed above, e.g., MPEG-2, MPEG-4, H.263, H.264, H.HEVC, or any combination thereof, to provide an initial encoded bitstream.

The first pass MPAQ encoding module 202 may provide a distortion value, mbDist, and an initial target bitrate, mbTarget_old, for each coding unit of the source, e.g., for each MB of each frame. The initial target bitrate may be a uniform target bitrate for all coding units of the source which may be calculated as (a certain percentage of) the average bits spending/used per MB over a frame after the first pass MPAQ encoding module 202. Additionally, the first pass MPAQ encoding module 202 may also provide the distortion value for each coding unit, which may define an end-to-end distortion between the source and the reconstructed coding units post the initial encoding step. The distortion value for each coding unit may be generated using a number of distortion measures, either alone or in combination, such as sum of squared error distortion (SSD), sum of absolute error distortion (SAD), Structural SIMilarity (SSIM), and etc.

The target bitrate modulator 204 may use the distortion value and the initial target bitrate along with an activity value for each coding unit to generate an updated target bitrate, mbTarget′. The activity value may represent an amount of texture contained in the source data. The output mbTarget′, the modulated bitrate, may then be provided to the second pass MPAQ encoding module 206. A standard block (not shown) may generate a new MB QP from the modulated bitrate mbTarget′ and a MB QP from the first pass MPAQ encoding module 202. The second pass MPAQ encoding module 206 implementing the same standard as the first pass module may then provide the coded bitstream, which may show improved subjective video quality, based on the new MB QP generated by the standard block.

It is noted that the various elements of the example video encoder of FIG. 2 may be built from electronic circuitry components and may include one or more application specific integrated circuits (ASICs). Alternatively, one or more of these elements may be implemented using one or more computing systems programmed to perform the functions of the element. The computing systems may include one or more processing units (e.g. processors) and electronic media encoded with executable instructions for performing the functions of one or more elements.

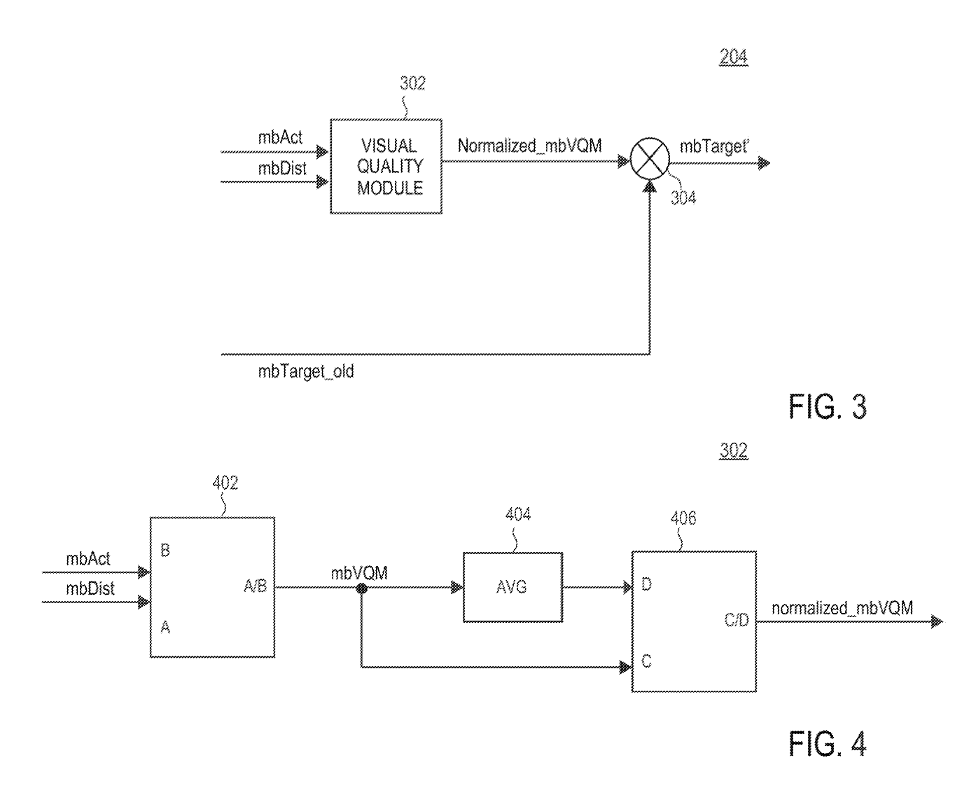

FIG. 3 is a schematic diagram of an example target bitrate modulator 204 according to the present disclosure. The example target bitrate modulator 204 may be implemented in the encoder 200 or may be implemented in various other encoders that utilized bitrate modulation. The target bitrate modulator is to modulate or alter a target bitrate for a coding unit of source data, e.g., a MB of a frame of the source data, based on various statistical parameters of the source data and characteristics of the encoder, such as encoder 100, itself. For example, the distortion may reflect the nature of the encoder as well as the source data statistics. The target bitrate modulator 204 includes a visual quality module 302 and a multiplier 304. The visual quality module 302 receives the activity value and the distortion value previously discussed and generates a normalized VQM for each coding unit of the source. The normalized VQM for each coding unit may then be multiplied by the initial target bitrate, mbTarget_old, to generate a new or modulated bitrate, mbTarget′, which may be used by the encoder 200 to guide the QP modulation, and hence improve the video quality of the coded bitstream.

The normalized VQM generated by the visual quality module 302 may be based on statistical parameters of individual coding units, e.g., MB, and parameters of the frame comprising the individual coding units. The normalized VQM may represent how well or bad a coding unit has been encoded in a pre-encoding pass compared to the average coding quality for the entire picture, e.g., frame. A high normalized VQM indicates a poor quality for a single coding unit. Since the object of the encoder is to achieve uniform quality for the entire picture, e.g., frame or source, in the encoding pass, then more bits may be used for a coding unit with a high normalized VQM in the second coding pass than in pre-encoding pass or first pass, and vice versa.

FIG. 4 is a schematic illustration of a visual quality module 302 according to the present disclosure. The visual quality module 302 may generate the normalized VQM and may implemented in various encoders and used in various ways. For example, the visual quality module 302 may be implemented in the encoder 200 to modulate a target bitrate for each coding unit of the source. Additionally or alternatively, the visual quality module 302 may also be used to modulate a QP for coding units, which will be described below. The visual quality module 302 may include a first processing unit 402, an averaging unit 404 and a second processing unit 406. The visual quality module 302 is shown as individual blocks in FIG. 4 for ease of discussion but may be implemented in various ways. For example, the visual quality module 302 may be software executing on a processor or it may be dedicated hardware or a combination of the two. Further, the first and second processing units and the averaging unit may be the same processing unit. The manner in which the visual quality module 302 is implemented in not limiting and any such manner is within the scope of this disclosure.

As inputs, the first processing unit 402 may receive the distortion value and the activity value for each coding unit. The first processing unit 402 may combine the mbDist and the mbAct values for a coding unit to generate a mbVQM value for the coding unit. The mbVQM for each coding unit may be provided to both the averaging unit 404 and the second processing unit 406. The averaging unit 404 may accumulate all the mbVQM values for all the coding units of a frame in order to compute the average VQM for the frame, which is then provided to the second processing unit 406.

The second processing unit 406 may then generate the normalized VQM for each coding unit of the source or a frame of the source. The normalized VQM may be determined by computing a ratio of the mbVQM for a coding unit to the average how well or bad a coding unit has been encoded in the pre-encoding pass compared to the average coding quality for the entire frame. The normalized VQM, as noted, may then be used to improve the subjective video quality of the source, coding unit by coding unit, by modulating the new target bitrate for each coding unit.

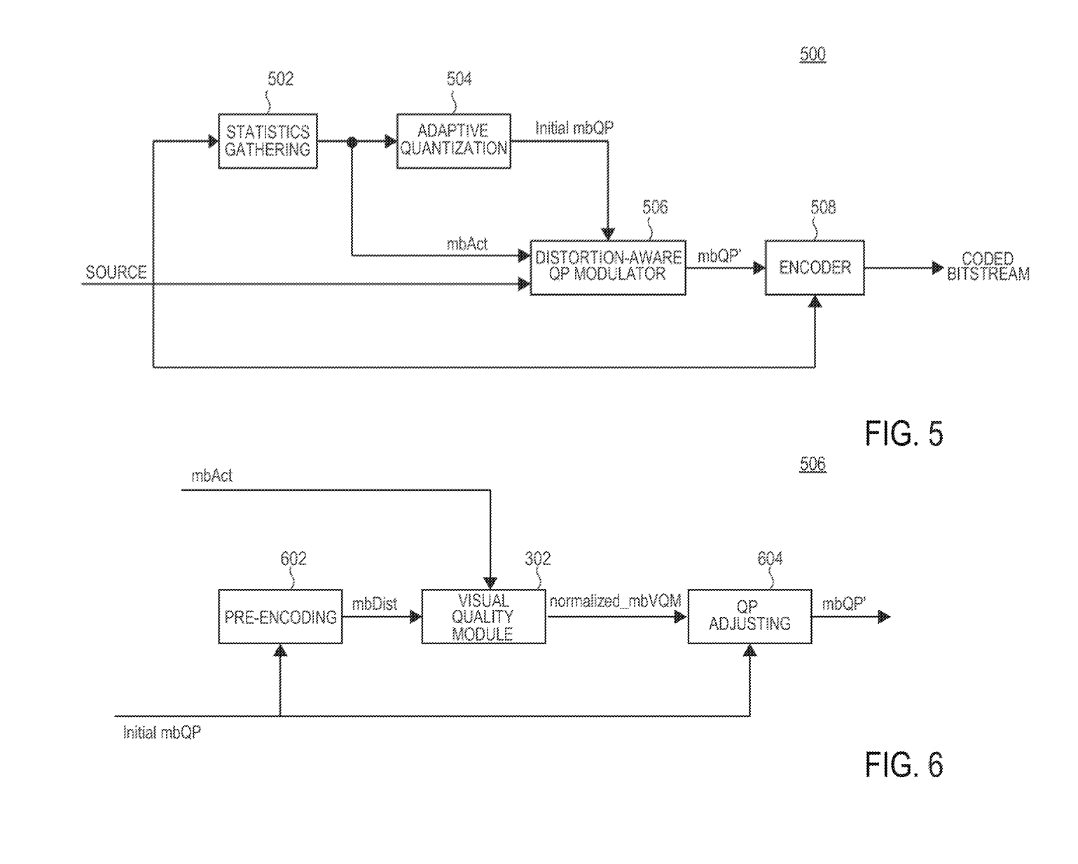

FIG. 5 is a schematic illustration an example encoder 500 implementing adaptive QP modulation according to the present disclosure. The encoder 500 may use the normalized VQM to modulate the QP for each coding unit of a frame, for example, in order to improve the video quality of the coded bitstream. The encoder 500 may implement a distortion-aware QP modulation technique that takes into account the distortion, the activity and an initial QP of a coding unit, e.g., a MB, for a basis of modulating the QP of that coding block. The encoder 500 may include a statistics gathering unit 502, an adaptive quantization unit 504, a distortion-aware QP modulator 506, which may also include an encoder, and an encoder 508.

The statistics gathering unit 502 may be a pre-processor computing various statistics/parameters of the source, e.g., each MB and each frame of the source. One of the parameters the unit 502 computes may be the activity value, mbAct, for each coding unit. As noted above, the activity value may represent a level of texture in the source video. More specifically, the activity level for a coding unit, the mbAct, may be defined as the sum of absolute values of horizontal and vertical pixel differences within the coding unit, wherein the value of the pixels represents a luma value. For example, if the coding unit is 15 pixels by 15 pixels, then the activity value may be computed from the following formula:

$$mbAct = {\sum }_{y = 0}^{15} {\sum }_{x = 0}^{14} \vert pixel ( x , y ) - pixel ( x + 1 , y ) \vert + {\sum }_{y = 0}^{14} {\sum }_{x = 0}^{15} \vert pixel ( x , y ) - pixel ( x , y + 1 ) \vert .$$

Pixel(x,y) may represent the luma value for the pixel in the xth row and the yth column inside the coding unit. The activity value may be provided to the distortion-aware QP modulator 506 by the unit 502.

The adaptive quantization (AQ) unit 504 may generate the initial QP, mbQP, for each coding unit using any known QP calculation method. The AQ unit 504 may compute the initial QP using the activity value, mbAct, and various other statistics about the coding unit. The initial mbQP may be provided to the distortion-aware QP modulator 506.

As inputs, the distortion-aware QP modulator 506 may receive the source data and for each coding unit, the mbAct and the mbQP. Based on these inputs, the distortion-aware QP modulator 506 may generate an updated QP, mbQP′, or modulate the mbQP to provide the mbQP′ to the encoder 508. The encoder 508 may then use the mbQP′ to encode the source data to generate a coded bitstream with improved visual quality. By using statistics and parameters generated from the coding units being encoded, the encoder 500 may be content-adaptive and each coding unit is modulated using an improved QP in order to improve its subjective visual quality.

It is noted that the various elements of the example video encoder of FIG. 5 may be built from electronic circuitry components and may include one or more application specific integrated circuits (ASICs). Alternatively, one or more of these elements may be implemented using one or more computing systems programmed to perform the functions of the element. The computing systems may include one or more processing units (e.g. processors) and electronic media encoded with executable instructions for performing the functions of one or more elements.

FIG. 6 is a schematic diagram of an example distortion-aware QP modulator 506 according to the present disclosure. The QP modulator 506 may modulate the QP of a coding unit based on the activity value, the distortion value and the initial QP of the coding unit. The QP modulator 506 may be implemented in any video encoding system, such as the encoder 500, and may improve the subjective video quality of a coded bitstream. The QP modulator 506 may include a pre-encoding unit 602, the visual quality module 302 and a QP adjustment unit 604. The pre-encoding unit 602 may receive the source and the initial mbQP and encode coding units of the source based any known standard as discussed above. The pre-encoding unit 602 may generate and provide the distortion value to the visual quality module 302. The distortion value may be generated by any of the methods discussed above.

The visual quality module 302 may then receive the activity value, mbAct, from a statistics pre-processor, such as the unit 502 and the distortion value, mbDist, from the pre-encoding unit 602. For the sake of brevity, the function of the visual quality module 302 will not be repeated but will function similarly as described above. The visual quality module 302 may then generate the normalized VQM for each coding unit and provide the normalized VQM to the QP adjustment unit 604.

As noted above, the normalized VQM may represent how well or bad a coding unit has been encoded in the pre-encoding unit 602 compared to the average coding quality for the entire source or frame. A high normalized VQM may indicate a poor quality for one coding unit. Since one objective may be to achieve a uniform quality for the entire source in a final encoding step, then more bits may be added to this coding unit with the high normalized VQM in a subsequent encoding step than in the pre-encoding pass performed by the pre-encoding unit 602. An opposite operation may occur for a low normalized VQM, e.g., fewer bits may be used in the subsequent encoding step.

In the QP adjustment unit 604, the mbQP may be lowered/increased for a coding unit based on the normalized VQM value for that coding unit. Nominally, the higher the normalized VQM is, the lower the mbQP′ may be set. For example, using the H.264 quantization process, if the normalized VQM is equal to 2, which may mean the coding unit looks twice as bad as the average coding unit in that same frame. In order to double the coding quality to at least achieve the average coding quality, the mbQP for that coding unit may be lowered by 6. For other standards, the relation between the target and the mbQP may need to be replaced by the corresponding inverse function of the associated quantization curve.

The adjusted mbQP, mbQP′, may then be provided by the QP adjustment unit 604 to a subsequent encoder, such as the encoder 508. The subsequent encoder may use the modulated QP to encode the source data and to generate a coded bitstream displaying improved subjective video quality.

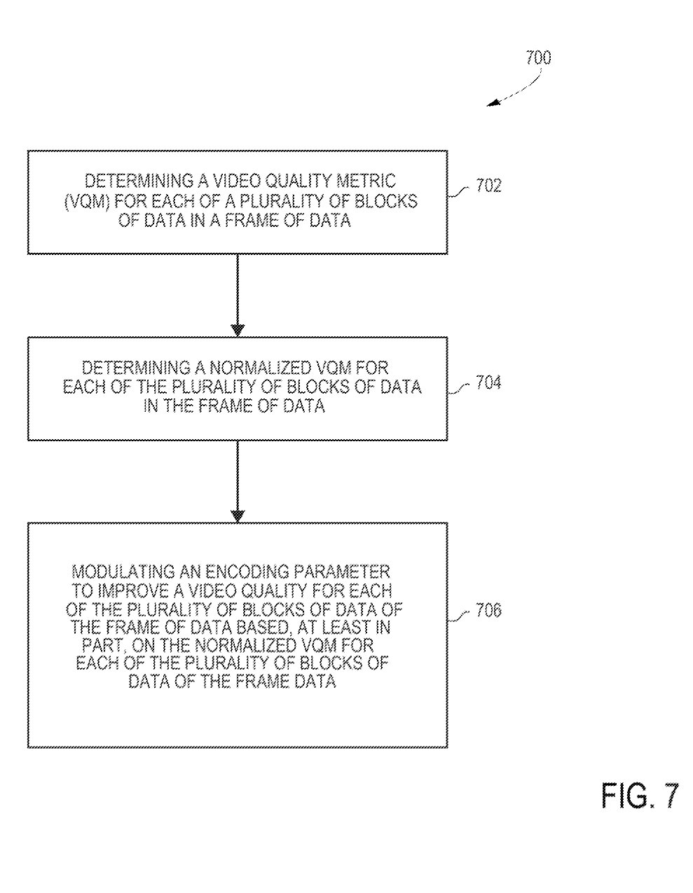

FIG. 7 is a flowchart illustrating an example encoding method 700 according to the present disclosure. The method 700 may be implemented to generate the normalized VQM and further to improve the video quality of a coded bitstream. The method 700 begins at block 702 with determining a VQM for each of a plurality of blocks of data in a frame of data. Determining the VQM for a plurality of blocks of data for the frame of data may involve computing a ratio of the distortion value to the activity value for each of the plurality of blocks of data as discussed above in regards to FIG. 4.

The method 700 may then continue at block 704 with determining a normalized VQM for each of the plurality of blocks of data of the frame of data. The determination of the normalized VQM for each of the blocks of data may comprise computing an average VQM for the frame of data and then taking the ratio of the mbVQM for a block of data to the average VQM for the frame of data associated with that data block. The steps associated with method block 704 may be similar to the computation of the normalized VQM as described in regards to FIG. 4.

Lastly, the method 700 may end at block 706 with modulating an encoding parameter to improve a video quality for each of the plurality of blocks of data of the frame of data based, at least in part, on the normalized VQM for each of the plurality of blocks of data of the frame of data. The encoding parameter may be a QP of each of the blocks of data as discussed in regards to FIG. 5 or it may be a target bitrate as discussed in regards to FIG. 2. In either implementation, the normalized VQM may be a basis for refining or adjusting a respective encoding parameter. The modulated encoding parameter may then be used to encode the source and to improve the subjective video quality of the coded bitstream.

The VQM may be defined based on the source statistics and feedback from a pre-encoding step, and it may reflect the content actual needs to encode the source data. The VQM may also solve drawback of other adaptive quantization techniques. In essence, the VQM may be a perceptual measurement to estimate the actual encoding needs of a data source. Due to the VQM considering the actual encoding performance feedback and is content adaptive, the VQM may provide better guidance than forward-feed-only estimation tools. The VQM may be calculated at different coding unit levels (e.g., MB, slice, and frame). Because of its versatility, the VQM may be used in various other points in the encoding process to improve the subjective video quality.

For example, the VQM may be used to adjust the rate-controller in second pass encoding to balance bits allocation among a number of frames in manners that high VQM value (in frame level) from the first encoding pass assign more bits to encode while a low VQM value give less bits to encode. For example, rather than only utilizing bits information from the first pass in existing D8 MPX second pass rate control, both bits and distortion (quality) information from the first coding pass is used instead. Moreover, the VQM may additionally or instead be used in the dual-pass statistical multiplexer (StatMUX). Based on the VQM (in frame level) from the first-pass encoding, the bits budget across different sources/channels may be adjusted in the second coding pass with better knowledge about the actual encoding performance of the content.

The VQM may also be used to adjust a deadzone control strength, forward quantization matrix, and quantization rounding offset. For MBs with high VQM values, the deadzone strength may be decreased, or the forward quantization matrix selection may be more uniform, or the quantization rounding offset may be increased, and vice versa.

Lastly, the VQM may also be used to bias a rate-distortion process, such as trellis optimization and mode decision. For example, the cost of a function may be adjusted toward more bits (lower QP) to reduce distortion for MBs with high VQM values, and vice versa.

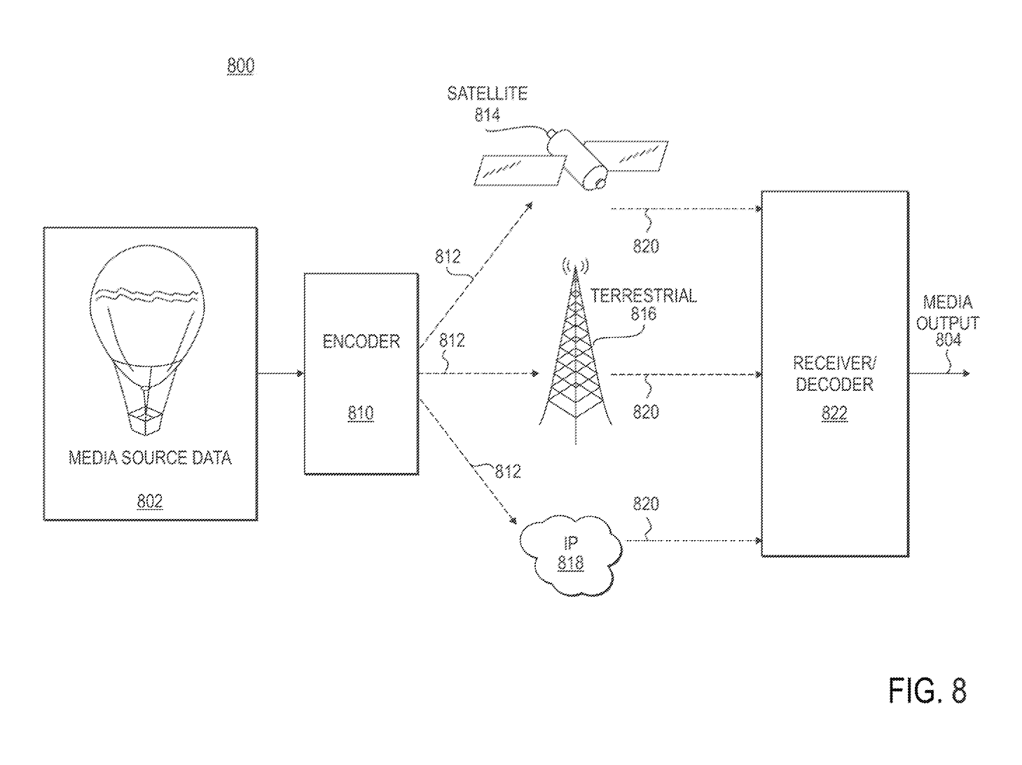

FIG. 8 is a schematic illustration of a media delivery system 800 in accordance with embodiments of the present invention. The media delivery system 800 may provide a mechanism for delivering a media source 802 to one or more of a variety of media output(s) 804. Although only one media source 802 and media output 804 are illustrated in FIG. 8, it is to be understood that any number may be used, and examples of the present invention may be used to broadcast and/or otherwise deliver media content to any number of media outputs.

The media source data 802 may be any source of media content, including but not limited to, video, audio, data, or combinations thereof. The media source data 802 may be, for example, audio and/or video data that may be captured using a camera, microphone, and/or other capturing devices, or may be generated or provided by a processing device. Media source data 802 may be analog and/or digital. When the media source data 802 is analog data, the media source data 802 may be converted to digital data using, for example, an analog-to-digital converter (ADC). Typically, to transmit the media source data 802, some mechanism for compression and/or encryption may be desirable. Accordingly, a video encoding system 810 may be provided that may filter and/or encode the media source data 802 using any methodologies in the art, known now or in the future, including encoding methods in accordance with video standards such as, but not limited to, H.264, HEVC, VC-1, VP8 or combinations of these or other encoding standards. The video encoding system 810 may be implemented with embodiments of the present invention described herein. For example, the video encoding system 810 may be implemented using the video encoding system 200 of FIG. 2 an/or 500 of FIG. 5.

The encoded data 812 may be provided to a communications link, such as a satellite 814, an antenna 816, and/or a network 818. The network 818 may be wired or wireless, and further may communicate using electrical and/or optical transmission. The antenna 816 may be a terrestrial antenna, and may, for example, receive and transmit conventional AM and FM signals, satellite signals, or other signals known in the art. The communications link may broadcast the encoded data 812, and in some examples may alter the encoded data 812 and broadcast the altered encoded data 812 (e.g. by re-encoding, adding to, or subtracting from the encoded data 812). The encoded data 820 provided from the communications link may be received by a receiver 822 that may include or be coupled to a decoder. The decoder may decode the encoded data 820 to provide one or more media outputs, with the media output 804 shown in FIG. 8. The receiver 822 may be included in or in communication with any number of devices, including but not limited to a modem, router, server, set-top box, laptop, desktop, computer, tablet, mobile phone, etc.

The media delivery system 800 of FIG. 8 and/or the video encoding system 810 may be utilized in a variety of segments of a content distribution industry.

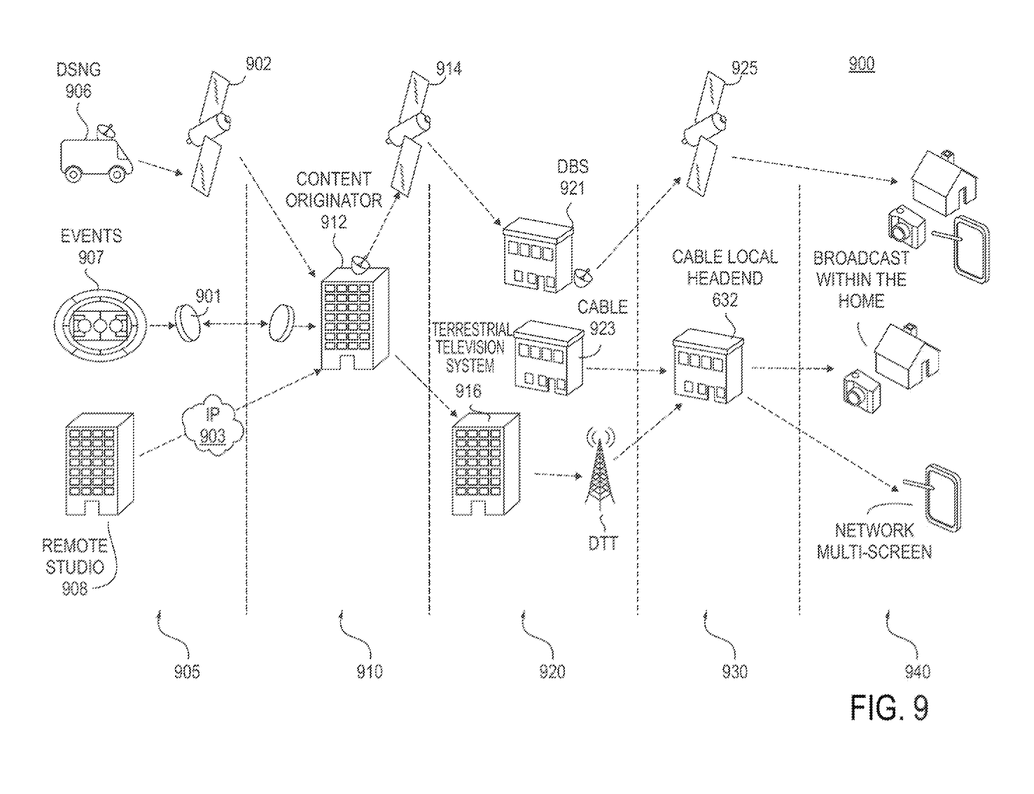

FIG. 9 is a schematic illustration of a video distribution system 900 that may make use of video encoding systems described herein. The video distribution system 900 includes video contributors 905. The video contributors 905 may include, but are not limited to, digital satellite news gathering systems 906, event broadcasts 907, and remote studios 908. Each or any of these video contributors 905 may utilize a video encoding system described herein, such as the video encoding system 200 of FIG. 2 and/or 500 of FIG. 5, to encode media source data and provide encoded data to a communications link. The digital satellite news gathering system 906 may provide encoded data to a satellite 902. The event broadcast 907 may provide encoded data to an antenna 901. The remote studio 908 may provide encoded data over a network 903.

A production segment 910 may include a content originator 912. The content originator 912 may receive encoded data from any or combinations of the video contributors 905. The content originator 912 may make the received content available, and may edit, combine, and/or manipulate any of the received content to make the content available. The content originator 912 may utilize video encoding systems described herein, such as the video encoding system 200 of FIG. 2 and/or 500 of FIG. 5, to provide encoded data to the satellite 914 (or another communications link). The content originator 912 may provide encoded data to a digital terrestrial television system 916 over a network or other communication link. In some examples, the content originator 912 may utilize a decoder to decode the content received from the contributor(s) 905. The content originator 912 may then re-encode data and provide the encoded data to the satellite 914. In other examples, the content originator 912 may not decode the received data, and may utilize a transcoder to change a coding format of the received data.

A primary distribution segment 920 may include a digital broadcast system 921, the digital terrestrial television system 916, and/or a cable system 923. The digital broadcasting system 921 may include a receiver, such as the receiver 822 described with reference to FIG. 8, to receive encoded data from the satellite 914. The digital terrestrial television system 916 may include a receiver, such as the receiver 822 described with reference to FIG. 8, to receive encoded data from the content originator 912. The cable system 923 may host its own content which may or may not have been received from the production segment 910 and/or the contributor segment 905. For example, the cable system 923 may provide its own media source data 802 as that which was described with reference to FIG. 8.

The digital broadcast system 921 may include a video encoding system, such as the video encoding system 200 of FIG. 2 and/or 500 of FIG. 5, to provide encoded data to the satellite 925. The cable system 923 may include a video encoding system, such as video encoding system 200 of FIG. 2 and/or 500 of FIG. 5, to provide encoded data over a network or other communications link to a cable local headend 932. A secondary distribution segment 930 may include, for example, the satellite 925 and/or the cable local headend 932.

The cable local headend 932 may include a video encoding system, such as the video encoding system 200 of FIG. 2 and/or 500 of FIG. 5, to provide encoded data to clients in a client segment 940 over a network or other communications link. The satellite 925 may broadcast signals to clients in the client segment 940. The client segment 940 may include any number of devices that may include receivers, such as the receiver 822 and associated decoder described with reference to FIG. 8, for decoding content, and ultimately, making content available to users. The client segment 940 may include devices such as set-top boxes, tablets, computers, servers, laptops, desktops, cell phones, etc.

Accordingly, filtering, encoding, and/or decoding may be utilized at any of a number of points in a video distribution system. Embodiments of the present invention may find use within any, or in some examples all, of these segments.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. A method for improving video quality, the method comprising:
determining a video quality metric (VQM) for each of a plurality of blocks of data in a frame of data;
determining a normalized VQM for each of the plurality of blocks of data in the frame of data; and
modulating an encoding parameter to improve a video quality for each of the plurality of blocks of data of the frame of data based, at least in part, on the normalized VQM for each of the plurality of blocks of data of the frame of data.

2. The method of claim 1, wherein the encoding parameter is a quantization parameter (QP) characteristic of each of the plurality of blocks of data in the frame of data.

3. The method of claim 1, wherein the encoding parameter is an encoding bit target for each of the plurality of blocks of data in the frame of data.

4. The method of claim 1, further comprising:
receiving an activity value for each of the plurality of blocks of data in the frame of data; and
receiving a distortion value for each of the plurality of blocks of data in the frame of data.

5. The method of claim 4, wherein determining a video quality metric (VQM) for each of a plurality of blocks of data in a frame of data comprises:
computing a ratio of the distortion value for each of the plurality of blocks to the activity value for each of the plurality of blocks of data.

6. The method of claim 1, further comprising determining an average VQM for the frame of data.

7. The method of claim 6, wherein determining a normalized VQM for each of the plurality of blocks of data in the frame of data comprises:
computing a ratio of the VQM for each of the plurality of blocks to the average VQM for the frame of data.

8. A video encoder comprising:
a video quality module configured to determine a video quality metric (VQM) for each data block of a plurality of data blocks; and
a modulator coupled to the video quality module and configured to modulate a video encoding parameter to improve the quality for each data block of the plurality of data blocks based on a normalized VQM for each data block of the plurality of data blocks.

9. The video encoder of claim 8, wherein the modulator is further configured to modulate a quantization parameter for each data block of the plurality of data blocks.

10. The video encoder of claim 8, wherein the modulator is further configured to modulate a target bit rate for each data block of the plurality of data blocks.

11. The video encoder of claim 8, wherein the video quality module is further configured to compute a ratio of a distortion value for each data block of the plurality of data blocks to an activity value for each data block of the plurality of data blocks.

12. The video encoder of claim 11, wherein the distortion value for each data block of the plurality of data blocks is based on at least one of:
a sum of absolute differences between the trial encoded coding unit and the corresponding coding unit of the stream of baseband video data;
a sum of squared differences between the trial encoded coding unit and the corresponding coding unit of the stream of baseband video data; or
a structural similarity index between the trial encoded coding unit and the corresponding coding unit of the stream of baseband video data.

13. The video encoder of claim 1, wherein the activity value for each data block of the plurality of data blocks is determined by a sum of absolute values of horizontal and vertical pixel differences within each data block of the plurality of data blocks.

14. The video encoder of claim 11, wherein the ratio of the distortion value for each data block of the plurality of data blocks to the activity value for each data block of the plurality of data blocks is the VQM for each data block of the plurality of data blocks.

15. The video encoder of claim 8, wherein the video quality module is further configured to determine an average VQM for the plurality of data blocks.

16. The video encoder of claim 8, wherein the modulator determines the normalized VQM for each data block of the plurality of data blocks by taking a ratio of the VQM for each data block of the plurality of data blocks to an average VQM for the plurality of data blocks.

17. A video encoding method to improve video quality, comprising:
determining a video quality metric (VQM) for each macroblock of the frame of video based on an activity value and a distortion value associated with each macroblock of the frame of video;
determining a normalized VQM for each macroblock of the frame of video based on an average VQM for the frame of video and the VQM for each macroblock of the frame of video; and
modulating an encoding parameter for each macroblock of the frame of video based on the normalized VQM for each macroblock of the frame of video.

18. The video encoding method of claim 17, further comprising:
receiving the activity value for each of macroblock of the frame of video; and
receiving the distortion value for each macroblock of the frame of video.

19. The video encoding method of claim 17, wherein the encoding parameter is a target bitrate and the target bitrate is modulated by computing a product of the normalized VQM for a macroblock of the frame of video and an initial target bitrate.

20. The video encoding method of claim 19, wherein the initial target bitrate is a uniform target bitrate set for the frame of video.

21. The video encoding method of claim 19, wherein the target bitrate is further modulated by a weighting factor.

22. The video encoding method of claim 17, wherein the encoding parameter is a quantization parameter.

23. The video encoding method of claim 17, further comprising determining the activity value for each macroblock of the frame of video by computing a sum of absolute values of horizontal and vertical pixel differences within a macroblock of the frame of video.

24. The video encoding method of claim 17, further comprising determining the distortion value for each macroblock of the frame of video by determining the distortion value for each macroblock of the frame of video after a pre-encoding process.
